(19) United States
(12) Patent Application Publication
(10) Pub. No.: US 2005/0242289 A1
(43) Pub. Date: Nov. 3, 2005

(54) Radiation monitoring system

(76) Inventors: James Grichnik, Hawthorn Woods, IL (US); James R. Bly, Hawthorn Woods, IL (US)

Correspondence Address: James R. Bly, 9 Darlington Dr., Hawthorn Woods, IL, 60047, US

(21) Appl. No.: 11/073,155

(22) Filed: Mar. 5, 2005

Related U.S. Application Data
(60) Provisional application No. 60/556,552, filed on Mar. 26, 2004.

(51) Int. Cl. G01T 1/11

(52) U.S. Cl. 250/370.07

(57) ABSTRACT

An monitor system that comprises a radiation rate meter and a dosimeter. The system is a pocket sized, portable, inexpensive, battery operated system and provides an instantaneous and accurate, indication of radiation above threshold levels to which the user has been exposed. The associated dosimeter measures radiation dosage levels and in conjunction with the dosimeter provides an indication of the cumulative radiation above threshold to which the user is subjected within a determined period.

This invention claims the priority filing date of provisional patent application Ser. No. 60/556,552 filed on Mar. 26, 2004.

### BACKGROUND OF INVENTION

Because exposure to an excessive level of radiation can be extremely harmful, many employers whose employees must work in a radioactive environment utilize programs whereby the employees are required to wear one or more dosimeter badges while at work.

Presently, there are various methods which are used to monitor the extent of exposure to radiation; however, radiological monitoring film is a preferred method. Radiological film has been used to monitor radioactive exposure in the workplace for over seventy years and this method remains the most widely used in the world. Essentially, when radiological film is used, each worker is required to wear a dosimeter badge carrying the radiological film. After a period of time, the badges are collected and analyzed to determine the amount of radioactive exposure. U.S. Pat. Nos. 6,127,685 and 6,198,108 describe a structure of standard type of radiological film badge and the film used therewith.

In operation, as radiation passes through a dosimeter badge, filters in the badge filter the radiation in order to produce a multiple-density image on the radiological film. This multiple-density image is analyzed and provides, essentially, a quantitative and visual record of both the amount of exposure, and the conditions that existed during the exposure. For example, the greater the density or film darkening on the radiological film, the greater the dose of radiation to which the radiological film was exposed. The image formed on the radiological film not only provides a visual record of the exposure, but also provides a permanent record of the exposure, that can be re-evaluated should the need arise. Typically, each radiological film includes embossed characters or coding thereon to allow each film to be identified in terms of who wore the badge in which that particular film was contained, and during what specific period of time.

Also, in many occupations and/or environments, there is a need to provide each person with radiation rate meters to instantaneously monitor radiation levels to which that person is exposed. In many instances, it is essential to know the actual instantaneous radiation dosage. For example, variations and trends in radiation dosage may need to be quickly identified, and an alarm indication given, so that appropriate action can be taken such as by removing personnel from areas where radiation levels that are hazardous. Also, upon the indication of an alarm appropriate corrective action may be initiated such as shutting down or adjusting radiation-producing equipment to radiation levels that are within safe limits. In nuclear plants, for example, instantaneous response is needed. Also in non-destructive testing an immediate “first” response is often necessary.

Electronic dosimeters and rate meters are known as for example disclosed in U.S. Pat. No. 5,132,543; however it has been found that the film badge is more reliable and useful and the electronic combination of the two meters has been less than satisfactory for a number of reason including much higher costs, and limited battery life. There are presently some systems having a rate meter and a dosimeter in the same electronic casing. However, there is always the question of reliability with today's technology since it is subject to electronic component failures during its useful life.

A rate meter is needed with a dosimeter since it is often essential to know promptly whether the radiation has been dangerous to the user the incident. Assume as another example that a user has been in a place where a first alarm is indicated by the rate meter and then a second alarm is indicated by the same rate meter, it is then even more critical to know whether that user has been subjected to a cumulative radiation that is dangerous. It is then crucial to send the dosimeter film for immediate checking.

### SUMMARY OF INVENTION

The present invention relates to a monitoring system or apparatus (hereafter also referred to as “monitor”) that comprises a combination dosimeter and a rate meter. The inventive monitor comprises a portable, inexpensive, pocket sized, battery-powered system that provides an instantaneous, accurate, indication of hazardous radiation levels to which the device is exposed. The monitor also provides a dosimeter that measures radiation dosage levels and the cumulative radiation within a determined period.

The foregoing features and advantages of the present invention will be apparent from the following more particular description of the invention. The accompanying drawings, listed herein below, are useful in explaining the invention.

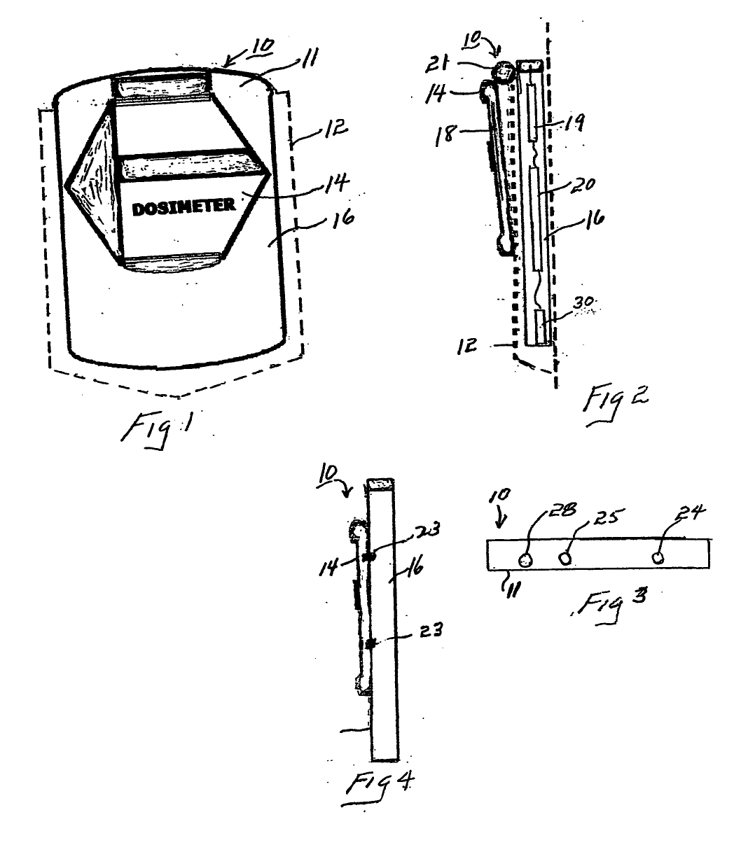

FIG. 1 is a front view of the inventive monitor;

FIG. 2 is a side view of the monitor of FIG. 1;

FIG. 3 shows a top view of the monitor; and

FIG. 4 shows a second embodiment of the invention.

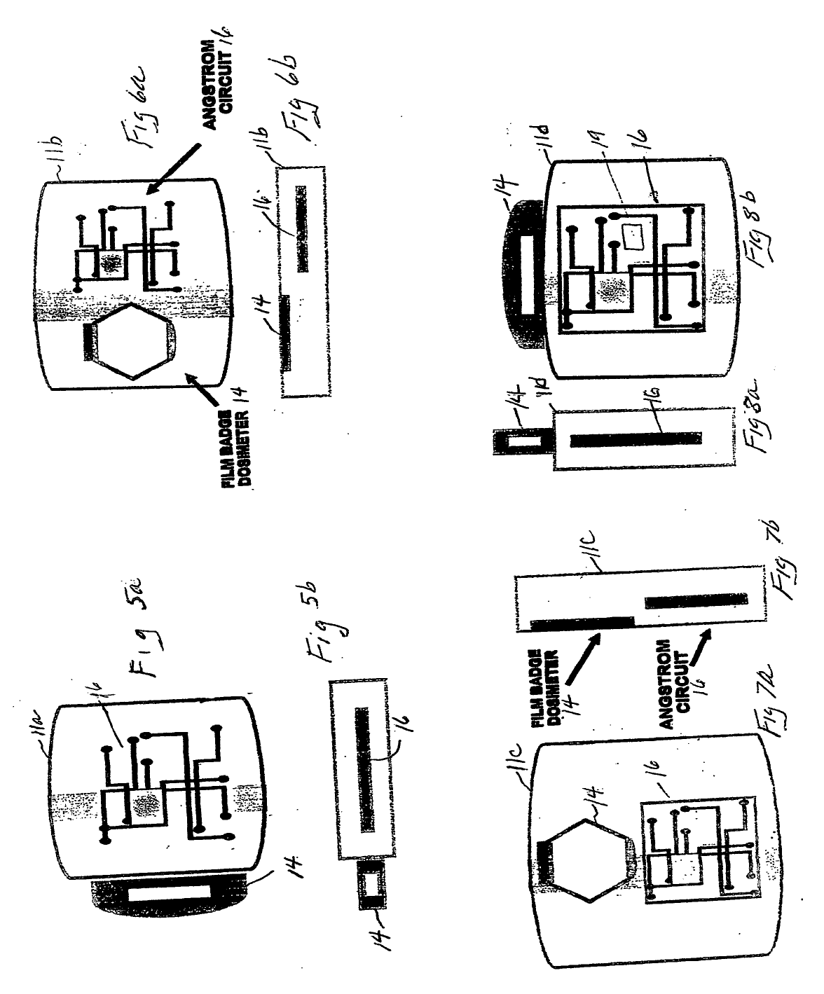

FIGS. 5a and 5b show an embodiment of the invention wherein the monitor comprises a film badge and an electronic rate meter (also labeled herein as the Angstrom circuit) that are mounted on separate pieces of hardware:

FIGS. 6a and 6b show an embodiment wherein the film badge dosimeter and the rate meter are mounted side by side on a card or holder;

FIGS. 7a and 7b show an embodiment similar to FIGS. 6a and 6b, but wherein the dosimeter and circuit are mounted one above the other rather than side by side; and

FIGS. 8a and 8b show an embodiment similar to FIGS. 5a and 5b but wherein the dosimeter and rate circuit are mounted in a vertical orientation, one unit above the other.

### DESCRIPTION OF THE INVENTION

FIG. 1 shows a front view of one embodiment of the inventive monitor 10 mounted in and on a case or housing 11. FIG. 2 shows a side of the system of FIG. 1. The case 11 is shown as being carried in the user's pocket, indicated by the dotted lines 12. The inventive monitor 10 comprises a film badge 14 and a rate meter 16. The film badge carries the film, indicated at 18. The rate meter carries a suitable known crystal wafer 19 and the associated electronic circuitry 20. These components can be selected for detection of a particular type of radiation such as from 50 keV (X-ray) to 2 mev (nuclear sources), as required. As indicated in FIG. 4, the monitor includes a test switch 24, a test indicating LED (light emitting diode) 25 and an alarm (red) LED 28. As discussed above, the rate meter 16 detects instantaneous radiation and the red LED 28 lights to provide a visual alarm if a threshold radiation level has been exceeded. A long life battery 30 supplies power to the detecting crystal, to the electronic circuitry and to the LED's.

The dosimeter film badge 14, which may be a well known type of “Landauer” badge that use a Luxel(R) optically stimulated luminescence dosimeter. The Landauer badge measures the total radiation to which the user has been exposed over a given period of time. Thus the monitor 10 can be characterized as including: (1) detecting means for detecting radiation; (2) processing means coupled to the detecting means for determining radiation dosage and rate of radiation; (3) LED means coupled to the processing means for indicating undesired levels of radiation; and (4) a battery for supplying operating power to the detecting means, processing means, and LEDs.

In the embodiment of the inventive monitor 10 as shown in FIGS. 1 and 2, the film badge 14 is mounted onto a spring clip 21, of suitable known design. The frame of clip 10 is, in turn, mounted to the upper end to the housing 11. The spring clip 21 is positioned and biased to bear against the outer surface of the housing to enable the badge to fasten to the user's garment, such as the pocket 12.

In the embodiment of the monitor 10 shown in FIG. 4, the film badge 14 is affixed by suitable means, such as small screws or clip pins to the housing 11. In this embodiment, the monitor 10 can be carried unobtrusively within the pocket of a garment.

FIGS. 5a and 5b show an embodiment of a monitor 10a wherein a film badge 14a is mounted on the side of the housing 11a containing the rate meter 16a, labeled also as the angstrom circuit that is mounted in housing 11a. An advantage or feature of this construction is that the dosimeter 14 and the circuit 16 are separate and each can be serviced, replaced or interchanged without affecting the other unit (14 or 16). Note also that the incoming radiation is monitored separately and the radiation is not superimposed, shielded or affected by radiation impinging on the other unit.

FIGS. 6a and 6b shown another embodiment of a monitor 10b wherein a film badge dosimeter 14 and the rate meter 16 are both mounted in a side by side relation within a same housing 11b. Note that as more clearly shown in FIG. 11b, the dosimeter 14 and rate meter 16 are mounted in a non-parallel relation such that radiation will not be shielded, superimposed or affected by radiation received by the other unit.

FIGS. 7a and 7b show an embodiment somewhat similar to that of FIGS. 6a and 6b wherein the two units 14 and 16 are mounted in the same housing 11c but located one above the other and in a non-parallel relation.

FIGS. 8a and 8b show and embodiment somewhat similar to that of FIGS. 5a and 5b wherein the dosimeter 14 is located adjacent the housing lid but the dosimeter 14 is mounted at the top of the housing above the rate meter 16.

From the showings of FIGS. 5a through 8b it will of course be appreciated that the specific location of the dosimeter 14 and the rate meter 16 within or adjacent the side of the housing 11 can be suitably varied without departing from the spirit of the invention. It has been found that if the source of radiation is mainly from a source on the ground, the dosimeter 14 can be positioned below the rate meter 16; if the source of radiation expected to be from a high point, the dosimeter 14 can be positioned above the rate meter 16. Also dependent on the user's requirements the dosimeter can be positioned on the right or left of the rate meter 16.

Advantageously, the power means, detecting means, processing means, and LEDs may be contained within the case or housing 11. In one embodiment housing is approximately 2.5″×2.0″×0.75″. Small size is quite important to assure the monitor is used by all personnel. FIGS. 1 and 2 show that the monitor may be conveniently carried in a user's pocket 12. Importantly, an audible alarm 19, as indicated in FIG. 8b, of any suitable known type can be provided for sounding an audible alarm in the event that the radiation rate exceeds a prescribed threshold, or for any other selected condition.

The present invention thus discloses a portable, light weight pocket dosimeter that provides an accurate quantitative measure of the radiation dosage to which the device has been exposed, and to the dosage rate to which the device is currently being exposed. It is a feature of the invention to provide an active pocket rate meter and dosimeter in a case that is small enough to be easily carried by an individual, e.g., in a shirt pocket, and sufficiently light weight and small to enable it to be carried without being obtrusive.

It is an additional feature of the invention to provide a pocket rate meter and dosimeter that include the above features and is also designed to minimize power consumption. The dosimeter utilizes no battery power, thereby providing maximum battery life, and minimizing the number of electronic components used therein, to provide a device having minimum size and cost, yet maximum reliability.

It will, of course, be appreciated that the disclosed system can be designed with wireless capabilities with minimal additional components.

In the embodiment shown in FIGS. 1 and 2, the spring clip 21 on the housing 11 enable the monitor 10 to be detachably secured (clipped) to a desired location, e.g., to the user's clothing. In the embodiments of FIGS. 5a-8b, the monitor may be carried in a user's pocket. Because of the small, light weight nature of the monitor 10, it can thus advantageously be positioned to an individual in a non objectionable manner.

While the invention has been particularly shown and described with reference to preferred embodiments thereof, it will be understood by those skilled in the art that various changes in form and details may be made therein without departing from the spirit and scope of the invention.

1. A combined radiation rate meter and dosimeter comprising,
a) a housing;
b) a rate meter including crystal means, electronic circuitry and a battery mounted within said housing;
c) a badge for carrying a radiation detecting film mountable adjacent said housing; and
d) alarm means mounted on said housing.

2. A monitoring system comprising for a radiation rate meter and a dosimeter comprising
a) a portable housing for attaching to the garment of a user;
b) sensing means, electronic circuitry and a battery mounted in said housing;
c) a badge for carrying a radiation detecting film mounted on said housing; and
d) alarm light means mounted on the exterior of said case.

3. A housing as in claim 2 wherein a spring loaded clipped is mounted on said housing for attaching said housing to the garment of a user.

4. A housing as in claim 3 wherein said badge is mounted on said housing by said clip.

5. A housing as in claim 2 wherein said badge is mounted to said exterior surface of said housing screws, and said housing and badge form an integral system that may be carried in a pocket of the user's garment.

6. A monitoring device as in claim 2 wherein said film is removable such as for processing and indicating the radiation effect thereon.

7. Apparatus as in claim 1 wherein said alarm means comprise LED's.

8. Apparatus as in claim 1 wherein said alarm means comprise audible alarms.

9. A monitoring system comprising a radiation rate meter and a dosimeter including
a) a portable housing for positioning on or in a garment of a user;
b) said rate meter comprising electronic circuitry, and a power source mounted in said housing;
c) a badge for carrying a radiation detecting film positioned adjacent said housing; and
d) alarm light means mounted on the exterior of said case.

10. Apparatus as in claim 9 wherein said badge and said rate meter are positioned in a non-parallel vertical relation.
